(19) United States
(12) Patent Application Publication
(10) Pub. No.: US 2010/0024030 A1
(43) Pub. Date: Jan. 28, 2010

(54) RESTARTABLE TRANSFORMATION AUTOMATON

(75) Inventors: Henricus Johannes Maria Meijer, Mercer Island, WA (US); John Wesley Dyer, Monroe, WA (US); Thomas Meschter, Renton, WA (US); Cyrus Najmabadi, New York, NY (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/178,168

(22) Filed: Jul. 23, 2008

(51) Int. Cl. H04L 9/32; G06F 7/00; G06F 17/30

(52) U.S. Cl. 726/18; 707/101; 707/E17.005

(57) ABSTRACT

Data transformation is lazily performed to facilitate reduced memory footprint, among other things. Rather than constituting an entire data structure, information is saved to enable iterative construction the structure. Moreover, an interface is afforded that appears to operate over a fully resolved structure but which is implemented on top of a restartable transformation mechanism that computes values in response to requests. These computed values could also be released based on one or more configurable policies.

### BACKGROUND

An automaton is an abstract model for a finite state machine (FSM) or simply a state machine. A state machine consists of a finite number of states, transitions between those states, as well as actions. States define a unique condition, status, configuration, mode, or the like at a given time. A transition function identifies a subsequent state and any corresponding action given current state and some input. In other words, upon receipt of input, a state machine can transition from a first state to a second state, and an action or output event can be performed as a function of the new state. A state machine is typically represented as a graph of nodes corresponding to states and optional actions and arrows or edges identifying transitions between states.

Automata are models for many different machines especially those that transition from state to state. Accordingly, automata can model state machines that transform data from one form to another as is often done with respect to program language processing.

In one instance, automata can provide bases for various compiler components such as parsers. Parsers include scanners or lexers that first perform lexical analysis on a program to identify language tokens. Subsequently or concurrently, parsers can perform syntactic analysis of the tokens. Parsers can be implemented utilizing automata that accept only language strings described by a language grammar. Input and tokens can either be accepted or rejected based on a resultant state upon stopping of the automaton. In other words, the input can be either recognized or unrecognized. In many cases, the parser employs recognized input to create a parse tree of tokens to enable subsequent processing (e.g., code generation, programmatic assistance, versioning . . . ).

Additionally, automata can be employed to perform serialization and deserialization. By way of example, automata can be employed to transform object graphs into a transfer syntax and subsequently reconstitute the objects graphs by transforming the transfer syntax back into objects. Such functionality is useful in transferring data over a network or saving and retrieving data from a computer-readable medium.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to restartable automata or state machines to facilitate data transformations from one form to another. Such transformations can correspond to parsing, serialization, and deserialization, among others. In accordance with one aspect of the disclosure, instead of eagerly computing resultant transformed data, the data can be computed lazily on an as needed basis. Further, an interface is afforded that appears to users to operate over a fully realized data set despite the fact that this is likely not the case. The interface can operate over a transformation state machine that can be restarted at various points to constitute enough data to satisfy requests, and which is free to constitute and/or release data in accordance with one or more policies.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a data interaction system in accordance with an aspect of the disclosure.

FIG. 2 is a block diagram of a representative management component in accordance with a disclosed aspect.

FIG. 3 is a block diagram of a data transformation system in accordance with an aspect of the disclosure.

FIG. 4 is a block diagram of a preprocess system that sets up mechanisms needed to support transformation starting/restarting in accordance with a disclosed aspect.

FIG. 5 is a block diagram of an exemplary parse tree produced in accordance with a parse tree only parser.

FIG. 6 is a block diagram of an exemplary parse tree instrumented to facilitate restarting in accordance with a disclosed aspect.

FIG. 7 is a block diagram of an exemplary parse tree showing reclaimed nodes in accordance with an aspect of the disclosure.

FIG. 8 is a flow chart diagram of a data transformation method in accordance with a disclosed aspect.

FIG. 9 is a flow chart diagram of a data processing method according to a disclosed aspect.

FIG. 10 is a flow chart diagram of a method of processing data in accordance with an aspect of the disclosure.

FIG. 11 is a flow chart diagram of an interface production method in accordance with an aspect of the disclosed subject matter.

FIG. 12 is a flow chart diagram of code generation method for transformation restarting in accordance with an aspect of the disclosure.

FIG. 13 is a schematic block diagram illustrating a suitable operating environment for aspects of the subject disclosure.

FIG. 14 is a schematic block diagram of a sample-computing environment.

### DETAILED DESCRIPTION

Systems and methods concerning data transformation are described in detail hereinafter. Data can be transformed from one form to another utilizing a transformation automaton or state machine. For example, data transformations are integral to parsing, serialization, and deserialization, amongst others. Rather than eagerly performing the transformation, it can be done lazily. In other words, instead of completely transforming data producing a new set of data or data structure, transformation can be performed as needed. Enough information is saved to enable transformed data to be realized iteratively. Furthermore, an interface is exposed for interaction with the transformed data that appears to users to operate over a fully resolved data set. However, the interface is implemented on top of a restartable transformation mechanism, which computes values on demand in response to requests, and which is free to release values based on configurable policies.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

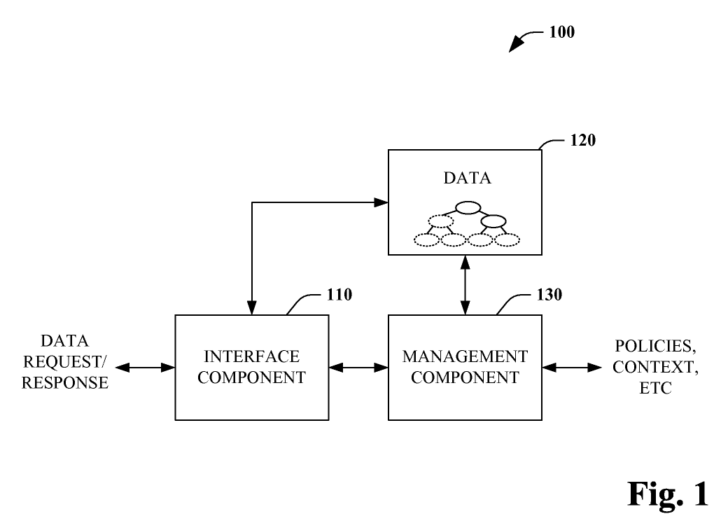

Referring initially to FIG. 1, a data interaction system 100 is illustrated in accordance with an aspect of the claimed subject matter. The system 100 includes an interface component 110 that facilitates interaction with data 120. For example, interface component 110 can receive requests and provision data satisfying the requests. In one implementation, the interface component 110 corresponds to an application-programming interface (API) that affords a plurality of mechanisms (e.g., functions, procedures . . . ) to support requests by computer programs. The interface component 110 also provides the illusion of complete data or data structure realization to interface users despite the fact that this is not likely the case. Indeed, the interface component 110 is communicatively coupled to the management component 130 that, among other things, ensures that requested data is constituted.

The management component 130 manages the current state of a set of data or a data structure 120. Rather than eagerly producing and saving an entire set of data 120 to memory, only a portion is produced such as that required to process a request. Constitution of large data sets can consume significant memory and degrade system performance. To address this issue, instead of storing the actual data, enough information can be stored to allow generation of the data. Data 120 can then be computed and cached lazily as needed. In other words, a recipe for how to produce the data or data structure 120 is stored and employed as needed to realize the data rather than the data or structure itself.

It is to be noted that in addition to realizing data, the management component 130 can also release constructed and cached data for system recovery and reuse (e.g., garbage collection) in accordance with one or more configurable policies, among other things. By way of example and not limitation, a policy can be specified that seeks to balance memory usage and processing time to optimize computer system performance. Consequently, data can be computed, cached, and/or removed. In one instance, data can be realized, released, and subsequently realized again as a function of available system resources. In other example, the policy can pertain to security in which certain portions of are released unless an individual and/or process has appropriate credentials.

Policies are not restricted to removal or un-realization of data. In fact, in some scenarios, policies can instruct the management component 130 to constitute data. By way of example, a predictive realization policy could be specified, which causes the management component 130 to constitute data proactively in anticipation that a future request will require such data. Inferences can be made from contextual information including historical usage patterns, data relationships, and program signatures, among other things, to aid identification of such data.

It is to be noted that since policies can control realization of data various monetization strategies are possible. For example, data can be unrealized or otherwise made unavailable in whole or part as a function of payment of a fee or other consideration.

Further, by way of example and not limitation, the interface component 110 provides a means for interacting with a parse tree generated by a parser as if the entire tree has been realized when only a portion has been realized at the initial time of interaction. As described above, one embodiment of the interface component 110 is an application programming interface. Of course, there are other equivalent means. In fact, any mechanism that hides information regarding the realization state of data from an entity seeking to interact with such data can comprise such means.

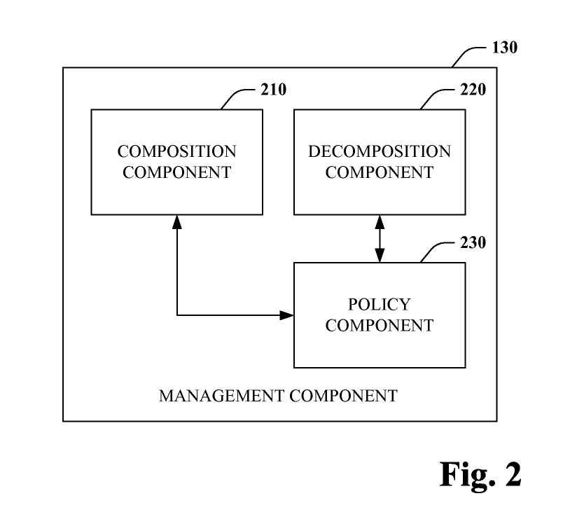

FIG. 2 depicts a representative management component 130 in accordance with an aspect of the claimed subject matter. As described above, the management component 130 automatically controls the state of data or a structure thereof. To that end, the management component 130 includes a composition component 210 and a decomposition component 220. The composition component 210 composes or initiates composition, realization or the like of data. As will be appreciated from further description infra, composition can correspond to execution of a transfer function on data to produce data of a different form, for example. Composed, produced, realized, or constituted data can subsequently or simultaneously by saved in memory or otherwise persisted. Conversely, the decomposition component 220 decomposes or otherwise makes data unavailable. In one instance, the decomposition component 220 can make data available for recovery and reuse by a computer system (e.g., garbage collector).

The management component 130 also includes a policy component 230 communicatively coupled to the composition component 210 and the decomposition component 220. The policy component 230 is a mechanism to facilitate specification and implementation of policies regarding realization of data. For instance, the policy component 230 can enable configuration of particular policies, specification of new policies, or importation of a third-party policy (e.g., plug-in). Further, the policy component 230 can receive, retrieve or otherwise obtain or acquire policy information such as the current memory utilization, and processor load to name but a few. Still further yet, the policy component 230 can resolve conflicts between policies based on priorities, inference, and/or user interaction, among other things. Finally, the policy component 230 can also initiate composition and/or decomposition by way of components 210 and 220, respectively, in accordance with one or more policies.

By way of example, not limitation, embodiments of the claimed subject matter may include a means for releasing computed data for system recapture and/or reuse in accordance with a memory usage policy. Such means can correspond to the management component 130, as described above. Of course, other equivalent means are also possible and contemplated. Moreover, any mechanism that causes data to be made available for subsequent use in accordance with a memory policy satisfies such means.

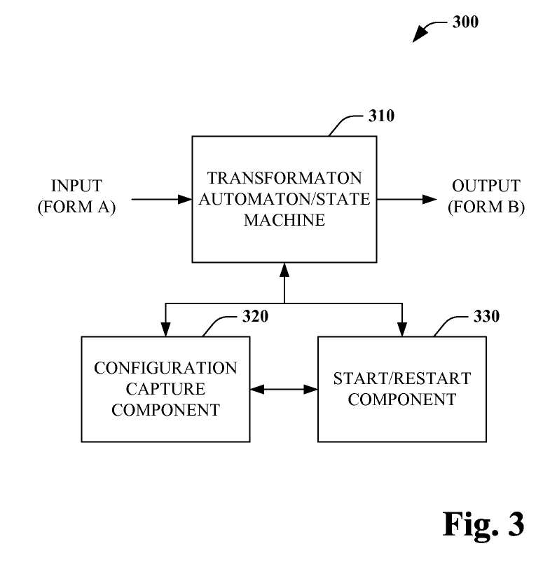

Turning attention to FIG. 3, a data transformation system 300 is illustrated in accordance with an aspect of the claimed subject matter. The system 300 includes a data transformation automaton or state machine component 310 that can receive and/or retrieve input data in a first form and outputs data of a second form. The state machine component 310 can be embodied in numerous manners.

In one instance, the state machine component 310 can correspond to a parser, which receives text or a sequence of characters and produces a parse tree. More particularly, the state machine component 310 first tokenizes the sequence of characters and then generates a parse or other similar tree structure (e.g., abstract syntax tree . . . ) as a function of a formal description, namely a grammar. In one particular case, the parser can form part of an integrated development environment (IDE) background compiler that affords assistance to programs by way of auto fill, intelligent assistance, colorization, formatting, and versioning, among other things. Furthermore, in some cases the state machine can be employed as a parser for recognition purposes rather than parse tree construction, as will be described in further detail below.

Other exemplary embodiments of state machine component 310 are for serialization and deserialization. During serialization (also referred to as deflating or marshalling), data of a particular form (e.g., object) is transformed into a transfer syntax to aid provisioning of such data across a network or storing data on a computer-readable medium. The dual, deserialization (also referred to as inflating or unmarshalling), reverses the process and transforms the transfer syntax back the original form or structure of data.

Still further yet, another embodiment of the state machine 310 can pertain to document formatting. For instance, a word processing and spreadsheet applications add or transform stored data into formatted data for presentation. By way of example, a word processing application transforms the data to add paragraph and spacing information for rendering to a display. State machine component 310 can perform such a transformation.

Various other embodiments of the of the transform automaton/state machine component 310 are possible and contemplated. The above provides a few exemplary embodiments to provide clarity and understanding with respect to aspects of the claimed subject matter. The claims are not intended to be limited to such embodiments.

The system 300 further comprises configuration capture component 320 and start/restart component 330. The configuration capture component 320 captures configurations of the state machine component 310 at various points. In other words, the state of the state machine is recorded. Where the state machine component 310 is embodied as a parser, configuration can include historical data such as that provided in a stack as well as a look-ahead buffer, among other things. The start/restart component 330 (hereinafter referred to as start component) is a mechanism that can initially start and/or subsequently restart transformation at a particular point utilizing a state machine configuration as captured by component 320.

By way of example, consider a parser scenario. There are generally two kinds of parsing, namely parsing to produce a tree and parsing to recognize a language. In this case, the state machine component 310 can be employed for both purposes. First, input can be parsed to recognize a language and determine the structure of data. During this recognition phase, a parser configuration can be captured by saving a marker of a production in the associated grammar at a particular point.

A parse tree need not by built eagerly and as a result reduces memory footprint. However, when a user desires to view parse tree data, the structure can be built on the fly by starting parsing at a particular point with the saved information. Although helpful in other situations, lazy computation of transformation data is particularly advantage with respect to large programs especially where multiple parse trees are need to enable versioning functionality such as undo or difference. Accordingly, it is to be noted that although not limited thereto the transformation automaton/state machine component 310 can comprise a means for lazy computation of data. Moreover, such means can include any equivalent mechanism that performs computations lazily, or on an as needed basis, rather than some time before.

The system 300 can operate similarly with respect to a serialization/deserialization scenario. Consider use of such techniques in the context of network transmission of data. In one instance, serialized data can be transmitted across a network to a target system. Subsequently, data can be constituted by applying a transformation that converts the transfer syntax into the original form of the data prior to serialization. Constitution of such data can be restarted many times to enable availability of data on an as needed basis. Various other strategies are also possible. For example, the data may not be serialized and/or transmitted to the target system until it is needed. Accordingly, starting or restarting of deserialization can initiate serialization and/or transfer of the data.

It is to be appreciated that configuration capture component 320 can afford a means for saving a parser configuration at a plurality of points in a parse. The subject claims are not limited to this particular embodiment and can include various alternate equivalents. In fact, any mechanism that can enables parser state to be saved at least temporarily for subsequent retrieval can comprise such means.

Similarly, start/restart component 330 can provide a means for starting the parser at a saved point in response to a request to compute data. Other equivalent means are also possible and intended to fall within the scope of the claimed subject matter. By way of example and not limitation, such means can include any mechanism that can start or restart data processing from a point utilizing retrievable state information.

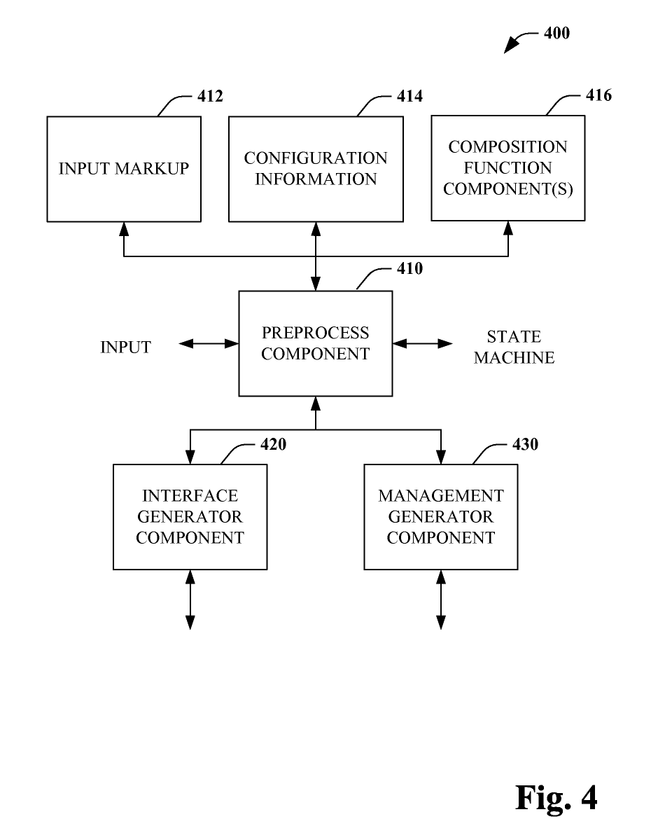

FIG. 4 depicts a preprocess system 400 that sets up mechanisms needed to support transformation starting/restarting in accordance with an aspect of the claimed subject matter. As shown, the system 400 includes a preprocess component 410 that interacts with an input designated for processing and a state machine that performs the processing. More specifically, the preprocessor component 410 generates a marked up input 412 to facilitate starting transformation at particular points in the input. For example, unique identifiers can be placed throughout the input denoting potential starting points. In addition, the preprocess component 410 can captures state machine state or configuration information 414 at each of the points. Furthermore, the preprocess component 410 can produce one or more composition function components 416 that are able to perform transformation at one or more of the points given the configuration information 414 to realize transformed data.

Still further yet, the preprocess component 410 can initiate action by interface generator component 420 and management generator component 430. The interface generator component 420 automatically generates an interface to enable interaction with transformed data. Moreover, such interface provides the appearance to users that results are completely realized even when in fact they are not. The management generator component 430 similarly automatically produces a management component, as previously described, to control application of transformation to realize data as well as remove data in accordance with one or more policies. Accordingly, in some instance data can be constituted, thrown away, and later reconstituted where needed.

What follows is a brief example to provide clarity and understanding to aspects of the claimed subject matter. As with other examples herein, this example is not meant to limit the claimed subject matter scope or spirit thereof. Although other embodiments are possible, the following example is framed in the context of parsing.

When a parsing system processes text it often executes actions or generates parse trees. However, these ideas can be merged to generate a parse tree of actions. By way of example, consider the following code, or sequence of characters, to be processed by a “parse tree” only parser:

```
namespace Outer1
{
    class Inner1 { }
    interface Inner2 { }
}
namespace Outer2
{
    delegate void Inner3( );
    enum Inner4 { }
}
```

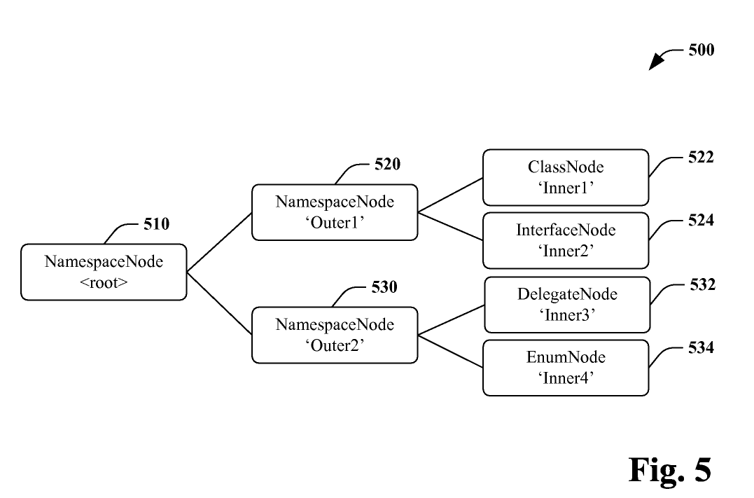

Referring to FIG. 5, an exemplary parse tree 500 that can be generated is illustrated. As shown, there is a root node 510 that is a parent to two namespace nodes “Outer1” 520 and “Outer2” 530 each of which have two children themselves, namely 522 and 523 as well as 532 and 534, respectively This parse tree 500 can be exposed through the following interface:

```
public partial interface INamespaceDeclarationNode
{
    INamespaceKeywordToken NamespaceKeyword { get; }
    IDottedNameNode DottedName { get; }
    ILeftCurlyToken LeftCurly { get; }
    IList<INamespaceMemberDeclaration> NamespaceMembers { get; }
    IRightCurlyToken RightCurly { get; }
}
```

In this case, the interface allows a user to navigate a fully constituted parse tree.

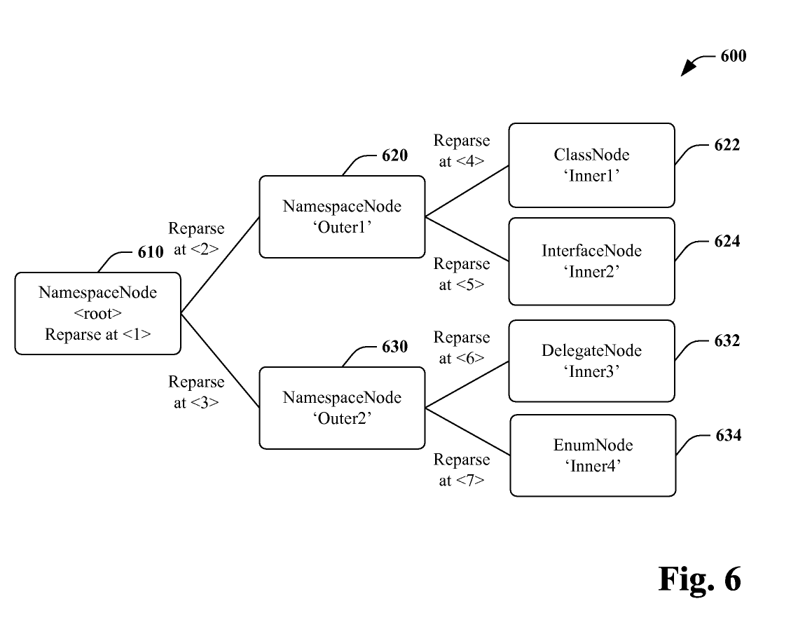

By contrast, consider the exemplary parse tree 600 of FIG. 6 that can be produced in accordance with an aspect of the claimed subject matter. Similar to previous parse tree 500, the parse tree 600 includes a root node 610, with two children “Outer1” 620 (with two children “Inner1” 622 and “Inner2” 624) and “Outer2” 630 (with children “Inner3” 632 and “Inner4” 634). Unlike the parse tree 500, links between nodes in the parse tree 600 are instrumented to identify points at which parsing can be performed. In this tree 600, “Reparse” is an action with associated state “<N>,” which includes both the parser configuration at that point as well as the upcoming stream represented as virtual positions in the original text as demonstrated below:

```
<1><2>namespace Outer1
{
    <4>class Inner1 { }
    <5>interface Inner2 { }
}
<3>namespace Outer2
{
    <6>delegate void Inner3( );
    <7>enum Inner4 { }
}
```

Suppose such a restartable system is employed to parse the above text. “NamespaceNode<root>” 610 might be returned back in response to a request and a user may not know whether or not the rest of the tree 600 is constructed and it does not matter. Data is kept about where in the text to start parsing and what should be parsed. To parse “Outer1 620”, where that portion of the tree is not built, reparsing starts at namespace “<2>” (“Reparse at <2>”). Now, “Outer1” 620 can be parsed without worrying about namespace “Outer2” 630. Each one of the reparse labels has a corresponding label in the text and data kept is the combination the label as well as the production below it.

The end goal of parsing here is to transform a flat sequence of characters in to a structure, namely a parse tree. However, parsing need not be performed eagerly. In one instance, solely a root is realized. In order to obtain data associated with children of the root, parsing is performed in the sequence at specified positions with appropriate starting context. In one embodiment, only that which is necessary to satisfy a request is realized. Accordingly, the children of the children of the root or leaf nodes are only parsed when needed thereby affording an iterative approach to tree construction. Of course, larger parsing granularity is also possible, for example, where entire sub-trees are generated.

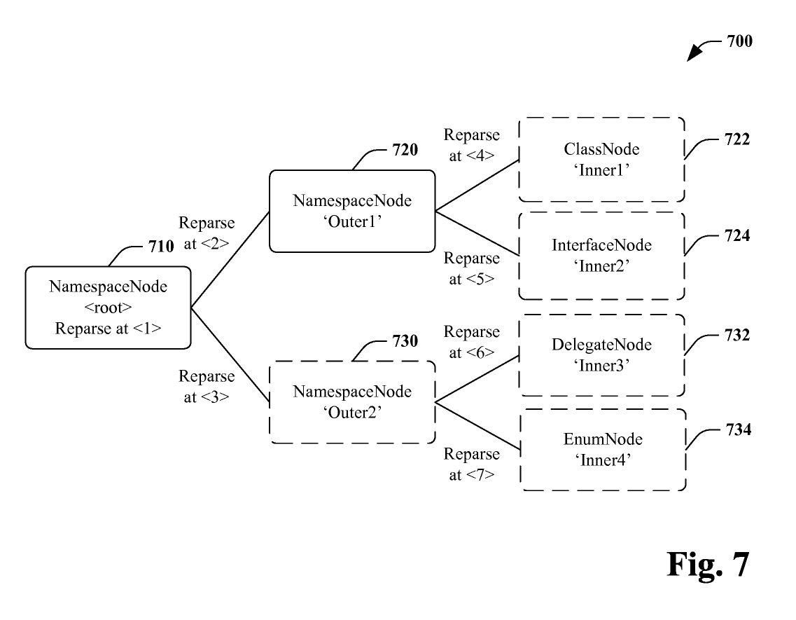

It is to be noted that policies such as lifetime policies can cause portions of a parse tree that were once realized to be released. Such a policy can be based on external calls, predefined special locations in the parse tree, memory pressure heuristics, or many other mechanisms. By way of example, consider parse tree 700 of FIG. 7 depicting a tree after one or more policies are applied. Here, the dashed boxes represent reclaimed parse tree nodes (730, 722, 724, 732, 734). In this case, if an interface consumer asks for the <root> namespace 710 for its children, the first “Outer1” node 720 would be returned immediately. Since the second node “Outer2” 730 was reclaimed, “Reparse at <3>” would be invoked, which would restart the parser with the appropriate configuration and input, run the necessary code to parse that node, and return. As a result, “Outer2” node 730 and possibly “Inner3” 732 and Inner4” 734 would be created, but this would not cause “Inner1” 722 and “Inner2” 724 to be created. Only the data that the consumer needs would be returned. This process could repeat indefinitely over the lifetime of the parse tree, in which nodes are created, released, and recreated, etc.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, policies can take advantage of such mechanisms, for example to predicatively realize and release data in furtherance of one or more goals.

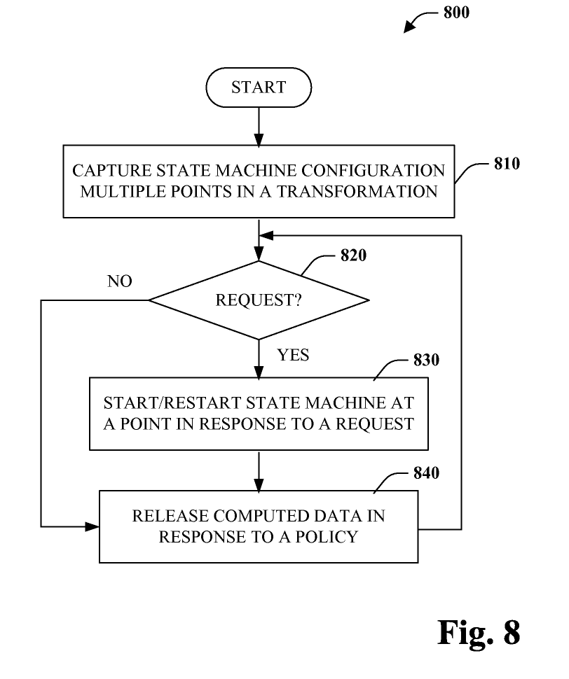

In view of the exemplary systems described supra, methodologies that may be implemented in accordance with the disclosed subject matter will be better appreciated with reference to the flow charts of FIGS. 8-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 8, a data transformation method 800 is illustrated in accordance with an aspect of the claimed subject matter. The method 800 can apply to any data transformation from a first form/format to a second form/format including without limitation parsing and serialization/deserialization. At reference numeral 810, state machine configuration or state is capture at numerous points in a transformation. At numeral 820, a check is made it determine if a request for transformed data has been received. If yes, the method continues at reference 830 in which the state machine is started or restarted at a particular point to produce the requested data. Subsequently, or if there is no request, the method proceeds at reference numeral 840 where constructed or computed data is released in accordance with one or more policies. For example, data can be released in an attempt to balance memory and processor usage. In an other instance, data can be released as a function of a security policy in which certain data only available to those with proper credentials The method then continues back to reference 820 where a check is again made concerning the presence of a request.

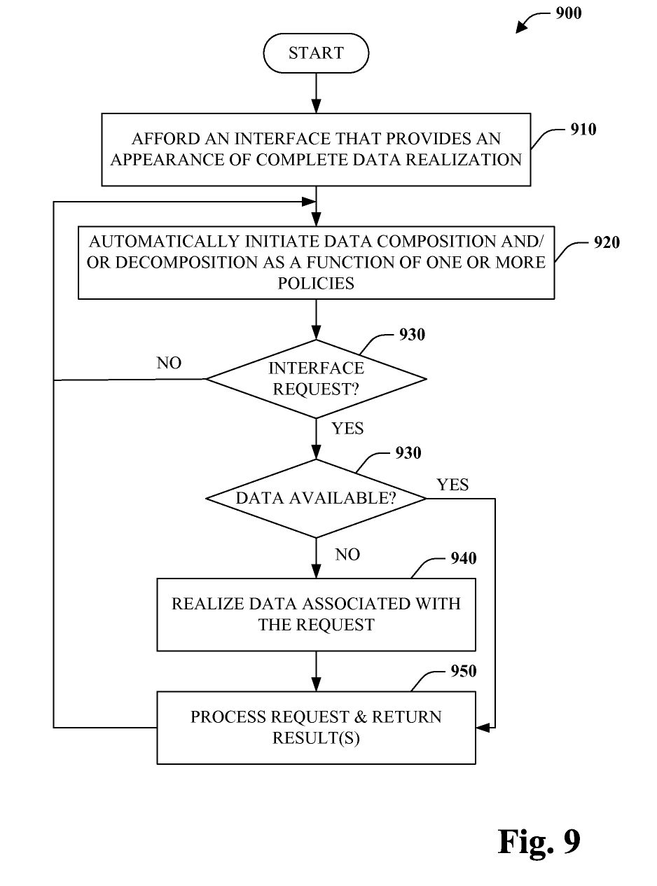

FIG. 9 is a method 900 of processing requests for data in accordance with an aspect of the claimed subject matter. At reference numeral 910, an interface is afforded to enable data interaction that provides the appearance of complete data realization regardless of whether that is in fact the case. At numeral 920, data composition and/or decomposition are initiated automatically in accordance with one or more policies. For instance, a predictive data policy can specify composition or realization of particular data likely to be requested in the near future. Additionally or alternatively, data can be decomposed or released in accordance with a memory usage policy identify a maximum usage rate. At reference 930, a determination is made as to whether an interface request has been received. If no, the method returns to numeral 920. Alternatively, if an interface request has been received the method continues at reference 930 where another determination is made regarding the availability of requested data. If the data is unavailable (“NO”), data necessary to process the request is realized at numeral 940. This can correspond to restarting a transformation automaton or state machine at particular points to construct required data. Subsequently or if all data is determined to be available at numeral 940 (“YES”), the request is processed and data returned to the requesting entity at 950. From there, the method can continue back at numeral 920.

Consider, for example, a deserialization application. An interface can be provided that appears to operate on a completely realized data structure. Upon a request for data, a deserialization function is called to generate requested data by transforming data in a transfer syntax to its original syntax. Data can continue to be produced as needed. However, after generation of more than a threshold level of data some of the data may be released in accordance with a memory management policy.

It is to be appreciated that disclosed techniques can be employed at multiple levels. For instance, data or recipes for computing data need not be transferred to a particular system and/or serialized until there is a request that prompts such action.

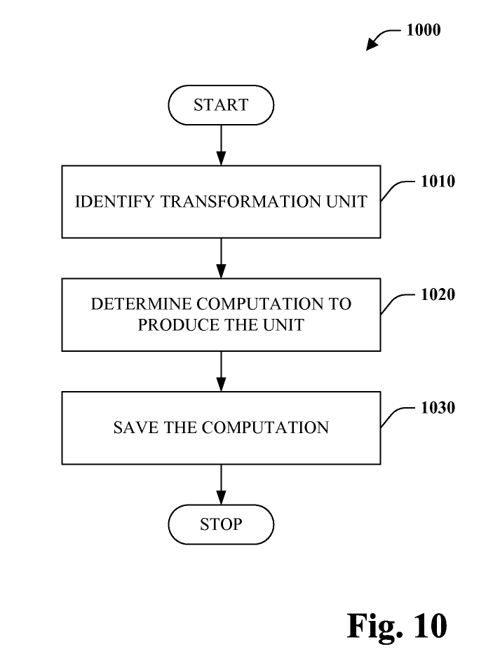

FIG. 10 a method 1000 of saving data is depicted in accordance with an aspect of the claimed subject matter. At reference numeral 1010, a transformation unit is identified. In a parser embodiment, the transformation unit can correspond to a parse tree node, for example. At reference 1020, a computation is determined that produces the transformation unit. Among other things, the computation can identify transformation state and a particular input location from which to start/restart. At reference 1030, the computation is saved. In accordance with an aspect of the claimed subject matter, the computation is smaller than the data it produces. In other words, a recipe for producing data is stored rather than the data itself.

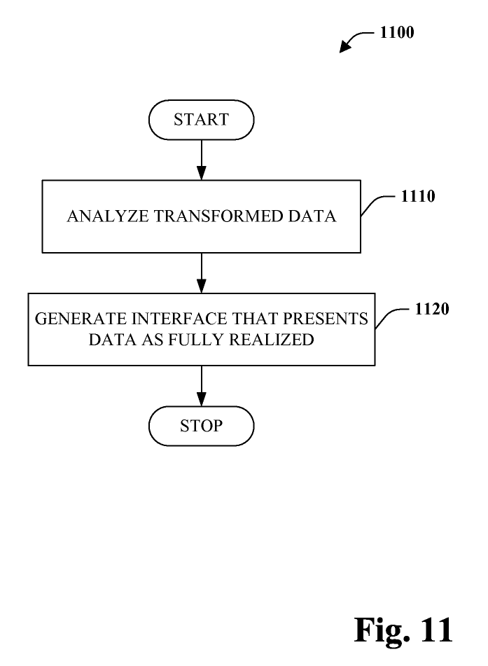

FIG. 11 is a flow chat diagram of a method of interface production 1100 according to an aspect of the claimed subject matter. At reference numeral 1110, transformed data is analyzed to determine is structure and/or format. Based thereon an interface is generated automatically to facilitate interaction with the transformed data. Moreover, it is to be appreciated that the interface provides the appearance of working with fully realized data set, when in fact that might not be the case. On the back end, the interface ensures that request data is realized such that users or consumers of the interface are not burdened with determining data state and constituting the appropriate data.

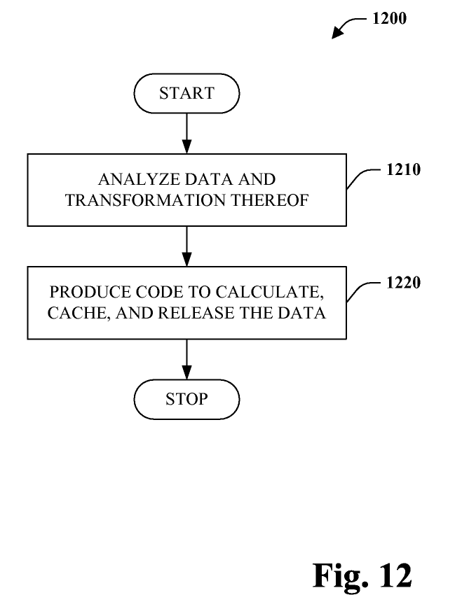

FIG. 12 illustrates a flow chart diagram of a code generation method 1200 that supports restartable data transformation. At reference numeral 1210, input data and transformation thereof are analyzed. As a function of the analysis, at reference 1220, mechanisms such as code are produced automatically or semi-automatically to effect calculation or construction of data, caching of both data and computations, and release of constructed data. These mechanisms can be hooked into the interface to insure requested data is realized automatically behind the scenes and policy evaluators related to the presence and/or lifetime of constructed data.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

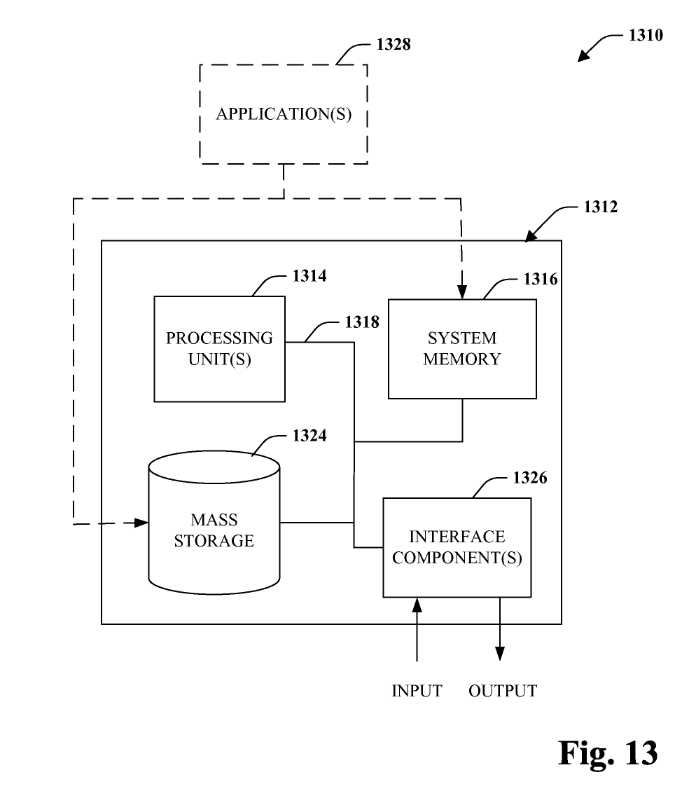

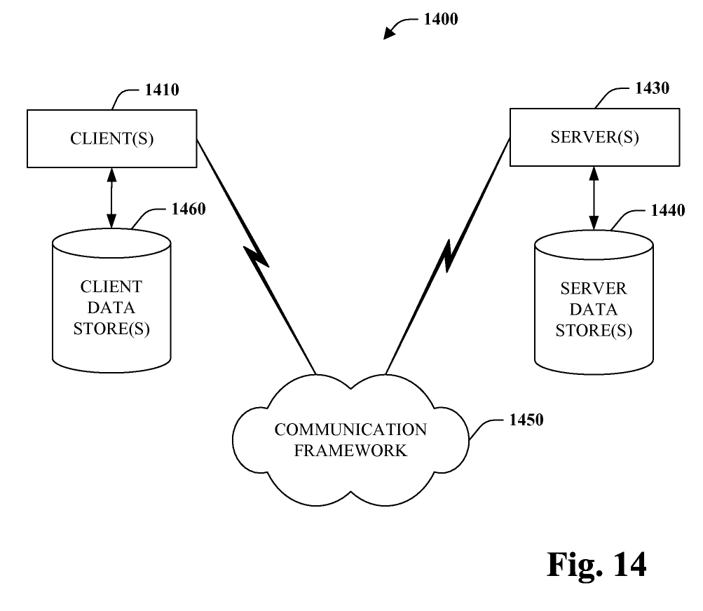

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316, and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 1314.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory, or memory stick. In addition, mass storage 1324 can include storage media separately or in combination with other storage media.

FIG. 13 provides software application(s) 1328 that act as an intermediary between users and/or other computers and the basic computer resources described in suitable operating environment 1310. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1312 to output device(s) via interface component 1326. Output devices can include displays (e.g., CRT, LCD, plasma . . . ), speakers, printers and other computers, among other things.

FIG. 14 is a schematic block diagram of a sample-computing environment a400 with which the subject innovation can interact. The system 1400 includes one or more client(s) 1410. The client(s) 1410 can be hardware and/or software (e.g., threads, processes, computing devices). The system 1200 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

Client/server interactions can be utilized with respect with respect to various aspects of the claimed subject matter. By way of example and not limitation, various mechanisms can be employed as network services. For instance, the interface component 110 can be resident on either a client 1410 or server 1430 and can receive and respond to requests for lazily constructed data across the communication framework 1450.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A data interaction system, comprising:
an interface component that facilitates interaction with transformed data and provides an appearance of complete data realization when the data is unrealized; and
a management component that initiates data composition and decomposition as a function of interface requests and one or more configuration policies, composition is performed lazily as needed to satisfy requests.

2. The system of claim 1, further comprising a state machine that transforms data from a first to a second format.

3. The system of claim 2, the management component restarts the state machine at various points to compose data.

4. The system of claim 3, further comprising a preprocess component that adds references to input data to facilitate start and stop of transformation.

5. The system of claim 4, the preprocess component produces one or more composition functions that perform data transformation to compose the transformed data in accordance with one or more of the references.

6. The system of claim 3, the state machine is a parser that transforms a sequence of tokens into a parse tree.

7. The system of claim 4, the parser forms part of an integrated development environment (IDE) compiler.

8. The system of claim 3, the state machine is a data serializer that transforms data to and/or from a transfer format.

9. The system of claim 1, the policy is a security policy that influences composition and/or decomposition based on user credentials.

10. The system of claim 1, further comprising a component that automatically generates the interface component and/or the management component as a function of the data and/or transformation thereof.

11. A data transformation method, comprising:
saving state machine configuration at transformation points; and
starting transformation from one of the points in response to a request and/or policy to produce transformed data lazily as needed.

12. The method of claim 11, further comprising caching the data.

13. The method of claim 12, further comprising releasing the data for system recovery and reuse.

14. The method of claim 13, releasing the data to reduce memory footprint.

15. The method of claim 11, further comprising denying production or releasing data unless proper credentials are supplied.

16. The method of claim 11, further comprising producing only the data necessary to satisfy the request.

17. The method of claim 11, comprising transforming data from a sequence of tokens into a parse tree.

18. A parsing system, comprising:
means for saving a parser configuration at a plurality of points in a parse in a preprocess phase; and
means for starting the parser at one of the points in response to a request initiating lazy computation of a minimal amount of parse tree data to satisfy the request in a parse tree generation phase.

19. The system of claim 18, further comprising a means for interacting with a parse tree generated by the parser as if the entire tree has been realized when only a portion has been realized at the initial time of interaction.

20. The system of claim 19, further comprising a means for releasing computed data for system recapture and/or reuse in accordance with a memory usage policy.
